(19) United States
(12) Patent Application Publication
(10) Pub. No.: US 2008/0048838 A1
(43) Pub. Date: Feb. 28, 2008

(54) Code upgrade

(75) Inventors: Michael Scott Montgomery, Boise, ID (US); Lin-Fat Chris. Lee, Boise, ID (US); William H. Pickel, Meridian, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company LP

(21) Appl. No.: 11/488,348

(22) Filed: Jul. 18, 2006

(51) Int. Cl. H04Q 5/22

(52) U.S. Cl. 340/10.51; 400/76

(57) ABSTRACT

Various embodiments and methods relating to a code upgrade are disclosed.

### CROSS-REFERENCE TO RELATED PATENT APPLICATIONS

The present application is related to co pending U.S. patent application Ser. No. ______ filed on the same date as the present application by Michael Scott Montgomery, Perry A. Miller and Wai Kwan Chan and entitled RF TAG, the full disclosure of which is hereby incorporated by reference

The present application is related to copending U.S. patent application Ser. No. ______ filed on the same date as the present application by Mehrban Jam, Salil Pradhan and Cyril Brignone and entitled METHOD AND APPARATUS FOR LOCALIZATION OF CONFIGURABLE DEVICES, the full disclosure of which is hereby incorporated by reference.

### BACKGROUND

Electronic devices may have many firmware or software code versions. Upgrading software or firmware code versions may be difficult.

### BRIEF DESCRIPTION OF THE DRAWINGS

FIG. 1 is a schematic illustration of one example of an electronic device upgrading system interacting with tagged devices which are packaged according to one example embodiment.

FIG. 2 is a schematic illustration of one example the tagged device of FIG. 1 according to an example embodiment.

FIG. 3 is a flow diagram illustrating one example upgrading method according to an example embodiment.

FIG. 4 is a schematic illustration of another embodiment of the upgrading system of FIG. 1 interacting with another embodiment of the tagged device of FIG. 1 according to an example embodiment.

### DETAILED DESCRIPTION OF THE EXAMPLE EMBODIMENTS

FIG. 1 schematically illustrates an electronic device upgrading system 10 according to one example embodiment. Upgrading system 10 is configured to record electronic code upgrades upon radio frequency (RF) tags associated with electronic devices. In one embodiment, system 10 is further configured to read information from tags to determine whether such electronic code upgrades should be transmitted to and recorded on tags. For purposes of this disclosure, the term “code” shall include computer readable instructions or language embodied as either software or firmware. For purposes of this disclosure, the term “code upgrade” shall mean any electronic computer readable code or language configured to change an existing code, library or language of an existing program or routine, examples of code upgrades including both electronic patches and complete or substantially complete packages of replacement code. Such code upgrades may be used to either (1) fix or repair a deficiency in the functionality of an existing routine or program (sometimes referred to as a bug), generally in response to accomplish a task that was unforeseen or set of operating circumstances or (2). to add a feature or a function to a program to upgrade the functionality of an existing routine or program (firmware or software). For purposes of this disclosure, the term “electronic patch” shall mean a section of digital code or software configured to be placed in a patch area of generated code so that the entire program or library would not be installed or replaced to implement or accomplish the repair or fix.

In the particular example illustrated, system 10 is illustrated as interacting with tagged devices 12A, 12B and 12C (collectively referred to as tagged devices 12) which include tags 14A, 14B and 14C (collectively referred to as tags 14) associated with electronic devices 16A, 16B and 16C (collectively referred to as electronic devices 16), respectively. Tags 14 comprise transponders configured to record data and to transmit data. In particular, each tag 14 is configured to receive data from device 22 and/or device 24 and to record such data in a memory. In one embodiment, tags 14 are configured to receive such data from device 22 or device 24 while deriving power from device 22 or device 24 or from a battery while an associated electronic device 16 is inactive, off or unpowered.

Each tag 14 is further configured to communicate such recorded data to its associated electronic device 16. In one embodiment, each tag 14 is configured to be hard wired to its associated electronic device 16, wherein data is transmitted from tag 14 to the electronic device 16 through the wired connection. As a result, such data transmission is fast, reliable and inexpensive. Each tag 14 is further configured to be powered through the wired connection from device 16 when device 16 is powered or active. In other embodiments, tag 14 may be configured to communicate with its electronic device 16 or or receive power in other fashions such as wirelessly.

In particular embodiments, tag 14 is configured to be removed from electronic device 16. In one embodiment, tag 14 is configured to be removed from its associated electronic device 16 without tools. As a result, tag 14 may be easily removed for repair, replacement or reuse with another electronic device.

In particular embodiments, tag 14 is additionally configured to communicate with device 22 and/or device 24. Such communication is performed wirelessly. In one embodiment, tag 14 is configured to communicate information to device 22 and/or device 24 indicating the data stored in its memory. As a result, tag 14 enables device 22 or device 24 to determine whether new or replacement code should be transmitted to tag 14 and recorded on tag 14.

According to one example embodiment, tags 14 each comprise an integrated circuit and a coupling device. The integrated circuit stores data while the coupling device interfaces with a RF device such as devices 22 and 24. In one embodiment, the coupling device includes a coil which acts as a transmitting antenna. In one embodiment, tags 14 employ load modulation or electromagnetic backscatter at its antenna to send data back to devices 22. In the embodiment illustrated, each tag 14 comprises an antenna connected to a capacitor and a silicon chip encapsulated together and bonded onto a substrate, such as a resilient acrylic or mylar substrate. In one embodiment, tag 14 derives power from devices such as device 22 or device 24 using either inductive coupling or electromagnetic capture. In other embodiments, tags 14 may include batteries. In one embodiment, tags 14 additionally include flash memory configured to store recorded data. In other embodiment, tags 14 may have other configurations.

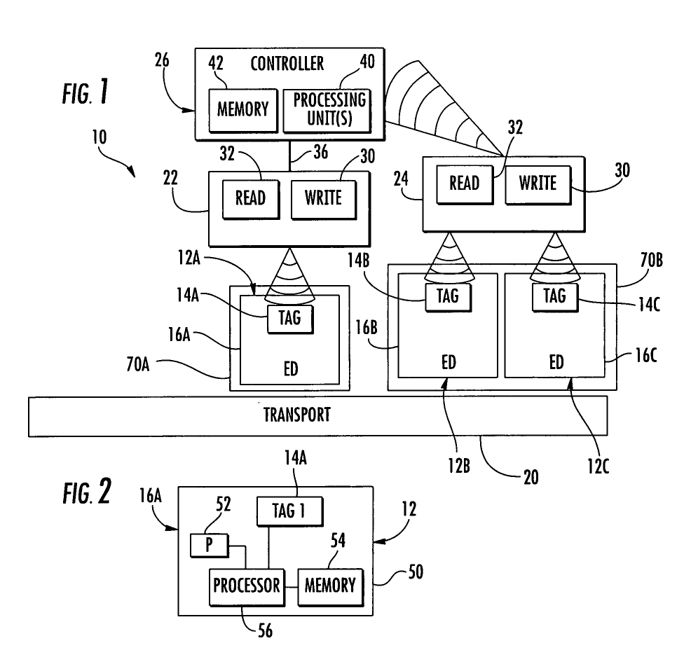

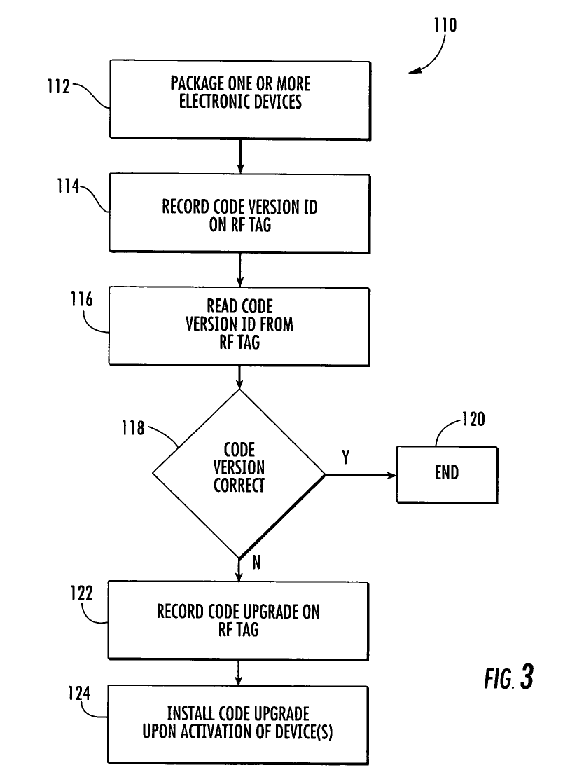

FIG. 2 schematically illustrates electronic device 16A of one of tagged devices 12 in more detail. Electronic device 16A comprises a device configured to perform one or more functions electronically. Examples of electronic device 16A, include, but are not limited to, printers, digital cameras, scanners, projectors, televisions, facsimile machines, all-in-one devices and the like. As shown by FIG. 2, electronic device 16A includes housing 50, power source 52, memory 54 and processor 56. Housing 50 comprises one of more structures configured to support and at least partially enclose those components of electronic device 16A. In other embodiments, housing 50 may additionally enclose tag 14A. Housing 50 may have any of a variety of sizes and shapes.

Power source 52 comprises a source of power for electronic device 16A including processor 56. In one embodiment, power source 52 may comprise a battery. In other embodiments, power source 52 may comprise a connector or adapter configured to be connected to an external power supply. The supply of power from power source 52 to those components of electronic device 16A results in activation of electronic device 16A. For purposes of this disclosure, the term “active” means that the device is generally under full power and is ready to receive input to from a person to perform its functions. For example, a printer, when active, is ready to print data and is under full power.

Memory 54 comprises a data storage device configured to store data and instructions for processor 56. Memory 54 stores software and operating instructions for electronic device 16A. Examples of memory 54 include any one or combination of volatile memory elements such as random access memory (RAM, DRAM, SRAM and the like) and nonvolatile memory elements (RAM, ROM, hard drive, tape, CD-ROM and the like). Memory 54 may incorporate electronic, magnetic, optical and/or other types of storage media. Memory 54 may also have a distributed architecture, were in various components are located remote from one another but can be accessed by processor 56.

Processor 56 comprises one or more processing units configured to generate control signals for actuating components of electronic device 16A. Processor 56 follows instruction code stored in memory 54. For purposes of this disclosure, the term “processing unit” shall mean a presently developed or future developed processing unit that executes sequences of instructions contained in a memory. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. Controller 26 is not limited to any specific combination of hardware circuitry and software, or to any particular source for the instructions executed by the processing unit.

As further shown by FIG. 2, processor 56 is in operable communication with tag 14A. Upon activation of electronic device 16A or the supply of power from power source 52 to processor 56, processor 56 extracts code upgrades stored in tag 14A and records and/or installs the code upgrades in memory 54. For example, in one embodiment, memory 54 may contain a code image. Processor 56 is configured to extract code upgrades, comprising a secondary code image, from tag 14A and to apply the secondary code image to the code image in memory 54. As a result, electronic device 16A is configured to upgrade its software or firmware contained in memory 54 using electronic data or code upgrades wirelessly transmitted to tag 14A. In one embodiment, processor 56 is hard wired to tag 14A, facilitating efficient data transfer. In other embodiments, Processor 56 may communicate with tag 14A wirelessly.

In some embodiments, processor 56 is further configured to record a code identifier or ID of the existing code stored in memory 54 on tag 14A. For example, processor 56 may be configured to record onto tag 14A model information, software or firmware version information or other data indicating the current code version of the software or firmware installed on electronic device 16A. Such information facilitates the detection of the existing status of any upgrades or installation of code upgrades on electronic device 16A by upgrading system 10, which enables upgrading system 10 to determine which code upgrades should be written to tag 14A.

Electronic devices 16B and 16C may be similar or different than device 16A while also having the same described components. In the example illustrated, devices 16B and 16C are configured to cooperate with one another when in use. For example, devices 16A and 16B may be bundled. In one embodiment, device 16B may comprise a digital camera while device 16C comprises a printer having a communication port for receiving picture data from the camera. In such embodiments where devices 16 are bundled, it may be beneficial to concurrently provide code upgrades to such devices to facilitate desired working operation between such devices.

As shown by FIG. 1, upgrading system 10 includes transport 20, RF devices 22, 24 and controller 26. Transport 20 comprises a device configured to move electronic devices 16 relative to RF devices 22, 24. In one embodiment, transport 20 comprises a device configured to position electronic devices 16 in sufficiently close proximity to RF devices 22, 24 to facilitate at least recording of data to tags 14 by RF devices 22, 24. In one embodiment, transport 20 may comprise a conveyor. In other embodiments, transport 20 may comprise other material handling equipment. In still other embodiments, transport 20 may be omitted where RF devices 22, 24 are moved into sufficiently close proximity with electronic devices 16 in other manners.

RF devices 22, 24 (sometimes referred to as “readers”) comprise devices configured to record data to tags 14 wirelessly such as through radio frequency waves. In the particular example illustrated, RF devices 22, 24 additionally configured to read data from tags 14 wirelessly, such as using radio frequency waves. As schematically shown in FIG. 1, each of RF devices 22, 24 includes RF write componentry 30 and RF read componentry 32. In other embodiments, RF devices 22, 24 may alternatively omit read componentry 32. One example of an RF device is the LR 200B Long Range Reader commercially available from Fieg Electronic of Weilburg, Germany, wherein the reader has modified addressing to handle additional memory

RF device 22 and RF device 24 differ in their communication with controller 26. In the particular example illustrated, RF device 22 is connected to controller 26 by a communication line 36. Examples of communication line 36 include electrical wiring, optical lines and the like. RF device 24 is configured to communicate with controller 26 wirelessly. In one embodiment, RF device 24 includes an RF transponder (and controller 26 also includes a RF transponder) for communication with controller 26 using radiofrequency waves. In other embodiments, RF device 24 may communicate with controller 26 in other wireless fashions. For example, in other embodiments, RF device 24 may communicate with controller 26 using infrared or other waves.

Controller 26 comprises one or more processing units 40 and associated memory 42 configured to generate control signals directing the recording of code upgrades by RF devices 22 and 24 to tags 14. In the particular embodiment illustrated in which RF devices 22 and 24 are additionally configured to read data from tags 14, controller 26 is also additionally configured to generate such control signals based upon data read from tags 14. For example, in one embodiment, controller 26 is configured to analyze data read from each tag 14 and select one or more code upgrades from multiple potential code upgrades stored in memory 42 for transmission to tag 14. In particular embodiments, controller 26 may additionally or alternatively generate control signals causing selective transmission of code upgrades to different tags 14 based upon other data stored in memory 42 or input to controller 26 such as the particular intended use or intended user of the associated electronic device 16.

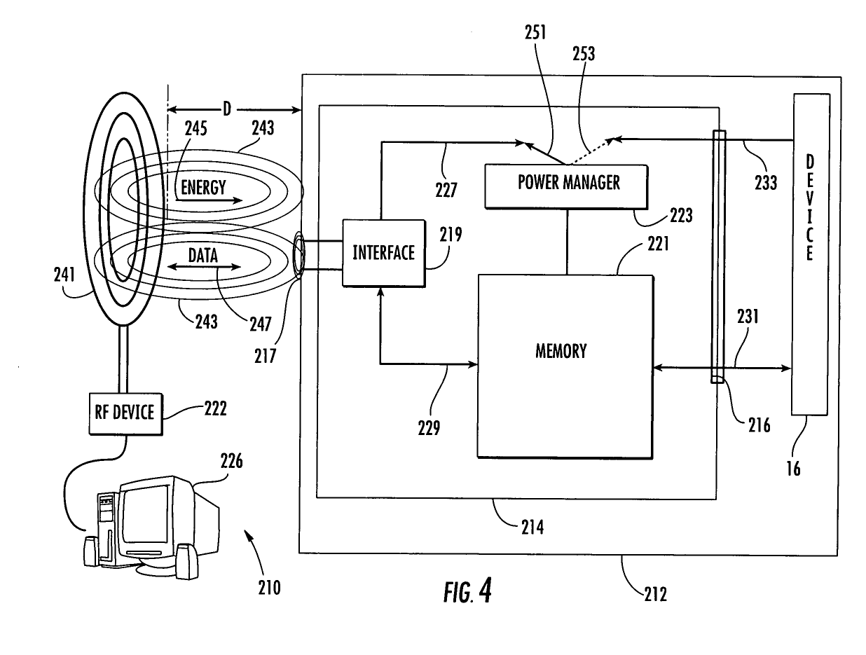

FIG. 3 is a flow diagram illustrating one example method 110 that upgrading system 10 (or another upgrading system) may utilize to configure tagged devices 12 (shown in FIG. 1). Method 110 permits electronic devices 16 to be upgraded or repaired with code upgrades that are transmitted to tags 14 while tags 14 and their associated electronic devices 16 (tagged devices 12) are already enclosed or substantially enclosed by packaging 70A or packaging 70B (collectively referred to as packaging 70) as shown in FIG. 1.

As indicated by step 112 of method 110 in FIG. 3, one or more electronic devices 16 are packaged with packaging 70. Packaging of electronic devices 16 may involve the positioning of tagged devices 12 within the packaging 70 or the positioning of packaging 70 about tagged devices 12 (shown in FIG. 1). Packaging 70 comprises any structure or structures that at least temporarily inhibit physical contacting access to the enclosed or partially enclosed electronic devices 16. Packaging 70 may be configured to temporarily protect and/or stabilize an associated electronic device 16 during storage, shipment or retail or wholesale display. In some embodiments, packaging 70 may be opaque. In other embodiments, packaging 70 may include portions that are translucent or transparent. Examples of packaging include, but are not limited to crates, cartons, boxes, shrink wrap and heat sealed translucent or transparent plastic thin films. Such packaging 70 may additionally include inner protective or stabilizing structures may being tagged devices 12 to the interior shape of packaging 70 or filling such as compressible foam peanuts or bubble wrap. Prior to activation of electronic device 16, electronic device 16 and its associated tag 14 are removed from packaging 70.

As indicated by step 114 in FIG. 3, a code identification or ID is recorded on tag 14. The code ID identifies the current or existing code version of the associated electronic device 16. The code version ID enables upgrading system 10 (shown FIG. 1) to identify the existing state or status of the software or firmware of electronic device 16. The code version ID is generally smaller than the actual code itself. For example, in one embodiment, a code version ID may comprise a software or program name and its version. The code version ID enables upgrading system 10 (shown FIG. 1) to identify the existing state or status of the software or firmware of electronic device 16.

In one embodiment, the code version ID is recorded on tag 14 using a RF device, such as device 22 or device 24, wirelessly after tag 14 and device 12 have been packaged. For example, a manufacturing facility may construct electronic device 16, package electronic device 16 and prior to shipping, wirelessly transmit the identification of the code version on the packaged electronic device to tag 14. In other embodiments, the code version ID may be recorded on tag 14 prior to the tagged device 12 being packaged. In such an embodiment, the recording of the code version ID onto tag 14 may be performed wirelessly or, in some embodiments, may be performed through a wired connection to tag 14. In such an embodiment, the recording of code version ID on tag 14 may be performed while the associated electronic device 16 is active, wherein electronic device 16 may assist or perform the recording of its code version ID onto tag 14. In yet other embodiments, the recording of code version ID onto tag 14 may be performed prior to the securing of tag 14 to its associated electronic device 16.

Steps 116-122 in FIG. 3 are steps performed by upgrading system 10 (shown in FIG. 1). Such steps may be performed at a time much later than the time at which electronic device 16 was initially configured or the time at which tagged device 12 was packaged. For example, electronic device may be configured at first point in time and may be inventoried or stored for a period of time. Tagged device 12 may packaged at a first point in time and may be in transit and/or inventoried for a prolonged period of time prior to reaching upgrading system 10. During such time, the original code version or the original programming of electronic device 16 may have become obsolete or out of date or errors or bugs with such original programming may have been identified.

As indicated by step 116 in FIG. 3, the existing code version of electronic device 16 is determined by upgrading system 10. In particular, controller 26 generates control signals directing device 22 or device 24 to read the code version ID from tag 14 of the electronic device 16. The code version ID is read from tag 14 in a wireless fashion using electromagnetic waves, such as radio frequency waves, which are transmitted through packaging 70 to tag 14 to activate or power tag 14. Upon being activated or being powered, tag 14 responds by transmitting the code version ID wirelessly through packaging 70 to the read component 32 of either RF device 22 or RF device 24.

As indicated by step 118, the read code version ID is transmitted from either RF device 22 or RF device 24 to controller 26. Processor 40 of controller 26 consults memory 42 and compares the read code version ID to the desired code version ID contained in memory 42. As indicated by step 120, if the code version ID read from tag 14 indicates that the operating code of device 16 is correct or are current, the process ends.

However, as indicated by step 122, if the code version ID read from tag 14 is not correct or is not current, such as when a bug or error has been identified since the initial code version of electronic device 16 or upgrades or enhancements have been developed since the initial version of code installed on electronic device 16, upgrading system 10 records a code upgrade on RF tag 14. In particular, processing unit(s) 40 of controller 26 generate control signals which are communicated to RF device 22 or RF device 24 and which direct RF device 22 or RF device 24 to record an appropriate code upgrade to tag 14. The code upgrade is wirelessly transmitted by write component 30 through packaging 70 to tag 14. The electromagnetic waves, such as radio frequency waves, transmitted by device 22 or device 24 empower and/or activate tag 14 while electronic device 16 is inactive or unpowered. In response to such waves, tag 14 records the code upgrade in its memory, such as flash memory. Once the desired or current code upgrade has been recorded on tag 14, device 12, while still in its packaging, may be further shipped for wholesale or retail sale or end the use.

As indicated by step 124, the code upgrade recorded on tag 14 is installed by electronic device 16 upon activation or powering up of electronic device 16. In particular, electronic device 16 installs the code upgrade in a patch area of its code or overwrites existing code to incorporate the code upgrade fix or code upgrade enhancement. In the particular embodiment illustrated, processor 56 of electronic device 16 (shown in FIG. 2) accesses the code upgrade stored on tag 14 through a wired connection and installs the code upgrade in memory 54. The wired connection facilitates fast, reliable and inexpensive transfer of the code upgrade. During such access, electronic device 16 powers tag 14 through the wired connection. In other embodiments, electronic device 16 accesses the code upgrade on tag 14 and powers tag 14 wirelessly.

Method 110 enables tagged devices 12 to be enhanced or fixed after being packaged. As shown by FIG. 1, multiple electronic devices 16, such as electronic devices 16B and 16C may be packaged in a single packaging 70B, wherein both electronic devices 16B and 16C may be provided with code upgrades. In particular embodiments in which electronic devices 16B and 16C are configured to cooperate or work with one another when in use, upgrading system 10 enables such grouped or bundled electronic devices to be upgraded or revised with appropriate code upgrades configured to enhance the cooperative relationship between such grouped devices. In other embodiments, upgrading system 10 may transmit code upgrades to single tagged devices 12 within a single packaging 70A. Because upgrading system 10 facilitates the upgrading or revising of electronic devices while such electronic devices are in packaging 70 and while electronic devices 16 are inactive or unpowered, electronic devices 16 may be upgraded or revised while being moved by transport 20, such as in a upgrading line on conveyor without such devices 16 being unpackaged or powered.

Although method 110 has been described as transmitting code upgrades to electronic devices while such electronic devices are in packaging per step 112, in other embodiments, method 110 may omit step 112. In such a method, upgrading system 10 transmits code upgrades to electronic devices 16 while electronic device 16 are inactive or are unpowered, also reducing costs and time associated with upgrading or reviseging such electronic devices.

Although method 110 is illustrated as including steps 114-120 in which system 10 determines whether a particular code upgrade should be recorded, in other embodiments, such steps may be omitted. For example, in other embodiments, upgrading system 10 may alternatively automatically record code upgrades on the RF tags 14 of each tag device 12 with which it interacts.

FIG. 4 schematically illustrates upgrading system 210 and tagged device 212, particular examples of upgrading system 10 and tagged device 12 shown in FIG. 1. Tagged device 212 includes tag 214 and an associated electronic device 16 (described above with respect to tagged device 12). Tag 214 comprises a transponder configured to communicate with device 16 through a wired connection. At the same time, tag 214 is also configured to communicate with upgrading system 210 wirelessly. In the embodiment illustrated, tag 214 includes two input/output ports, port 216, a wired port for communicating with device 16 and port 217, a radio frequency port 217 comprising a radio frequency coil or antenna that facilitates wireless communication between upgrading system 210 and tag 214. In the particular embodiment illustrated, tag 214 additionally includes interface 219, memory 221 and power manager 223. Interface 219 comprises that portion of an integrated circuit of tag 214 connected to the antenna of port 217 and configured (1) to facilitate communication from tag 214 to upgrading system 210 and (2) to facilitate the reception of both power and data wirelessly from upgrading system 210. When tag 214 is receiving power and data from upgrading system 210, interface 219 divides or separates the radio frequency waves 243 received via port 217 into their power or energy transmitting portions and their data transmitting portions. In particular, interface 219 demodulates the received radio frequency waves to pull or extract power off of the radio frequency waves, wherein the extracted power is transmitted to power manager 223 as indicated by arrow 227. At the same time, interface 219 transmits the extracted data component of the waves to memory 221 as indicated by arrow 229.

Memory 221 stores data transmitted by interface 219. In particular embodiments, memory 221 additionally stores a code version ID for device 16. In one embodiment, memory 221 is further connected to device 16 through port 216 as indicated by arrows 231. In one embodiment, memory 221 comprises a flash memory. In other embodiments, memory 221 may comprise other forms of memory.

Power manager 223 comprises a portion of an integrated circuit of tag 214 and is wired to memory 221 and to interface 219. Power manager 223 acts as a switch to selectively power memory 221 using power received from interface 219 (as indicated by arrow 227) or using power received from device 16 (as indicated by arrow 233). In particular, when device 16 is inactive or unpowered, power manager 223 is in the connection state shown by arrow 251 such that power extracted from radiofrequency waves 243 by interface 219 is transmitted to memory 221, permitting data in a memory 221 to be read or permitting data to be written to memory 221 by interface 219 as indicated by arrows 229 without power being received from device 16. When device 16 is powered or active, power manager 223 is in the connection state shown by broken arrow 253 such that power from device 16 is transmitted to memory 221, facilitating reading and writing of data to memory 221 by device 16 as indicated by arrows 231. In particular, when device 16 is inactive or unpowered, manager 223 supplies power to memory 221 by transmitting power received in from interface 219 as indicated by arrow 227.

In one embodiment, tag 214 comprises a dual port integrated circuit having to input/output ports including a radio frequency port and a serial interface I²C port, a 125 kHz carrier frequency for its RF. interface and 1 kB of non-volatile memory. In one embodiment, tag 214 is configured to power up in response to an RF signal when tag 214 is spaced from an antenna of upgrading system 210 by less than or equal to distance D. In one embodiment, distance D is approximately 1 m. The serial interface port is wired to device 16. Power from device 16 is used when device 16 is powered. One example of tag 214 is a duel port integrated circuit such as Atmel At24RF08 commercially available from Atmel Corporation. In other embodiments, other tags may be employed. For example, in other embodiments, tag 214 may alternatively operate at 13.56 MHz using ISO 15693 protocol. In such embodiment, memory 221 may have a non-volatile memory capacity of 8 kB. In yet other embodiments, tag 214 may operate at other frequencies and have other memory capacities.

Upgrading system 210 is similar to upgrading system 10. Upgrading system 210 determines the current status or state of electronic device 16 by reading the version of code installed on electronic device 16 or the code version ID stored on tag 214. Depending upon whether the code version of device 16 is out of date so as to benefit from an upgrade or would benefit from a code upgrade to correct errors, upgrading system 210 transmits one or more code upgrades wirelessly to tag 214, wherein the transmitted code upgrades are stored in memory 221. Upgrading system 210 includes RF device 222 and controller 226. RF device 222 is similar to RF device 22 in that RF device 222 is configured to read data from tag 214 and to record data to tag 214. As shown by FIG. 4, RF device 222 includes an antenna 241 through which electromagnetic radiation, such as radio frequency waves 243 are transmitted. Antenna 241 may have a variety of different sizes, shapes and configurations.

Controller 226 analyzes data read from tag 214, determines whether the electronic device 16 associated with tag 214 should receive a code upgrade, selects an appropriate code upgrade and generates control signals directing an RF device to transmit the selected code upgrade to tag 214 of tagged device 212. Like controller 26, controller 226 includes a one or more processing units 40 and a memory 42 (shown in FIG. 1). In the particular embodiment illustrated, controller 226 is embodied as a computer having a monitor. In the embodiment illustrated, controller 226 is configured to display the current code version of device 16 as read from tag 214, to display the recommended code upgrade, to generate an identification record including data identifying those electronic devices 16 and the code upgrades that have been transmitted to such devices 16. In particular embodiments, controller 226 may enable a user to override a code upgrade selected for a particular device 16 or select an alternative code upgrade for device 16. Controller 226 further facilitates uploading of new code upgrades to controller 226 as they become available. In other embodiments, controller 226 may comprise other computing devices.

In operation, tagged device 212 is positioned within distance D with respect to antenna 241. Controller 226 generates control signals directing device 222 to transmit waves 243 which are received by the antenna of port 217 of tag 214. During such transmission of waves 243, tag 214 is not receiving power from device 16 such as when device 16 is inactive or is unpowered. As indicated by arrow 245, the radio frequency waves 243 transmit energy which is received by interface 219 and transmitted to power manager 223 which further supplies power to memory 221. At the same time, as indicated by arrows 247, the radio frequency waves 243 are modulated so as to activate tag 214. Upon activation of tag 214, interface 219 modulates the antenna of port 217 to communicate the version of the code existing on device 16 and stored on memory 221. Such transmission may occur while tagged device 212 is contained within packaging. Should the data received from tag 214 indicate that device 16 should have a code upgrade, controller 226 generates control signals directing device 222 to modulate radio frequency waves 243 such that one or more selected code upgrades are transmitted wirelessly as indicated by arrows 247. Interface 219 receives such modulated radio frequency waves, representing the selected code upgrade, wherein the code upgrade is stored in memory 221 as indicated by arrow 229. The transmission of the code upgrade may also occur while tagged device 212 is contained within packaging.

Later on, upon being activated or powered up, device 16 supplies power to tag 214 through the hard wired port 216 as indicated by arrow 233. This power from device 16 is applied to memory 221 by power manager 223. Device 16 further accesses memory 221 and installs the code upgrade recorded on memory 221 to upgrade the program or routines of device 16 to enhance or to correct errors existing in the programs are routines of device 16.

Although the present disclosure has been described with reference to example embodiments, workers skilled in the art will recognize that changes may be made in form and detail without departing from the spirit and scope of the claimed subject matter. For example, although different example embodiments may have been described as including one or more features providing one or more benefits, it is contemplated that the described features may be interchanged with one another or alternatively be combined with one another in the described example embodiments or in other alternative embodiments. Because the technology of the present disclosure is relatively complex, not all changes in the technology are foreseeable. The present disclosure described with reference to the example embodiments and set forth in the following claims is manifestly intended to be as broad as possible. For example, unless specifically otherwise noted, the claims reciting a single particular element also encompass a plurality of such particular elements.

What is claimed is:

1. An apparatus comprising:
a device having code; and
a first radiofrequency (RF) tag associated with the device, the tag storing an upgrade for the code, wherein the device is configured to extract the upgrade from the tag upon being activated.

2. The apparatus of claim 1 further comprising packaging about the device.

3. The apparatus of claim 2, wherein the packaging extends about the RF tag.

4. The apparatus of claim 1 further comprising:
a second device having code;
a second RF tag associated with the second device; and
a packaging about the first device and the second device.

5. The apparatus of claim 4, wherein the first electronic device and the second electronic device are configured to operate with one another.

6. The apparatus of claim 4, wherein the first electronic device and the second electronic device are configured to operate independent of one another.

7. The apparatus of claim 4, wherein the first electronic device in the second electronic device are substantially identical and were in the first RF tag has the first stored code upgrade and were in the second RF tag has a second stored code upgrade.

8. The apparatus of claim 1, wherein the code upgrade is configured to upgrade the code.

9. The apparatus of claim 1, wherein the code upgrade is configured to correct errors in the code.

10. The apparatus of claim 1, wherein the RF tag is a dual-port EEprom RF tag.

11. The apparatus of claim 1, wherein the electronic device comprises a printer.

12. The apparatus of claim 1, wherein the RF tag has a memory of at least about 1 kB.

13. The apparatus of claim 1, wherein the device includes a code image and wherein the code upgrade is a secondary code image.

14. An apparatus comprising:
an electronic device having code; and
means associated with the device for receiving a code upgrade for the device without deriving power from the device.

15. A method comprising:
wirelessly transmitting a code upgrade to a first radiofrequency (RF) tag associated with an electronic device while the electronic device is out of communication with the tag.

16. The method of claim 15, further comprising extracting the code upgrade from the tag upon activation of the electronic device.

17. The method of claim 15, wherein the code upgrade is transmitted to the RF tag while the RF tag and the associated electronic device are contained within packaging.

18. The method of claim 15 further comprising wirelessly transmitting a second code upgrade to a second RF tag associated with a second electronic device while the first electronic device and the second electronic device are contained in a common package.

19. The method of claim 15 further comprising wirelessly reading data from the first RF tag to determine whether the first code upgrade should be transmitted to the first RF tag.

20. The method of claim 15, wherein the first RF tag is a dual port EEprom RF tag.
